(19) United States
(12) Patent Application Publication
(10) Pub. No.: US 2025/0184653 A1
(43) Pub. Date: Jun. 5, 2025

(54) Headset, Head-Mounted Device, and Headset Signal Processing Method

(71) Applicant: Huawei Technologies Co., Ltd., Shenzhen (CN)

(72) Inventors: Hui Yang, Beijing (CN); Libin Zhang, Beijing (CN); Zhihua Yang, Beijing (CN)

(21) Appl. No.: 19/048,362

(22) Filed: Feb. 7, 2025

Related U.S. Application Data
(63) Continuation of application No. PCT/CN2022/111020, filed on Aug. 9, 2022.

(51) Int. Cl. H04R 1/10; H04R 1/08

(52) U.S. Cl. CPC H04R 1/1083; H04R 1/083; H04R 1/1091; H04R 2201/107; H04R 2410/05; H04R 2460/13

(57) ABSTRACT

A headset has a first bone conduction microphone and a second bone conduction microphone. The first bone conduction microphone is attached to a head in a worn state. A first vibration signal collected by the first bone conduction microphone mainly includes a human voice signal and an ambient noise signal. The second bone conduction microphone is coupled to a fastener via a first flexible connection structure, and the second bone conduction microphone is separated from the head in the worn state. A second vibration signal collected by the second bone conduction microphone mainly includes the ambient noise signal. A controller in the headset can perform noise reduction processing on the first vibration signal based on the second vibration signal.

### CROSS-REFERENCE TO RELATED APPLICATIONS

This is a continuation of International Patent Application No. PCT/CN2022/111020 filed on Aug. 9, 2022, which is hereby incorporated by reference in its entirety.

### TECHNICAL FIELD

This disclosure relates to the field of headset technologies, and in particular, to a headset, a head-mounted device, and a headset signal processing method.

### BACKGROUND

A microphone used in a headset is usually an air conduction microphone, and the air conduction microphone collects human voice and ambient noise that are conducted in air.

Usually, the human voice is about 70 decibels (dB). However, in a high ambient noise scenario, the ambient noise is above 80 dB. As a result, the ambient noise drowns out the human voice, and the air conduction microphone cannot capture the human voice, which greatly affects a call of a user.

### SUMMARY

This disclosure provides a headset, a head-mounted device, and a headset signal processing method. The headset includes a first bone conduction microphone that is attached to a head in a worn state and a second bone conduction microphone that is connected to a fastener of the headset via a flexible connection structure and that is separated from the head in the worn state. The headset can effectively improve a call of a user. The following describes technical solutions provided in this disclosure.

According to a first aspect, this disclosure provides a headset. The headset includes a fastener, a first bone conduction microphone, a second bone conduction microphone, a first flexible connection structure, a speaker, and a controller. The first bone conduction microphone is connected to the fastener, and the first bone conduction microphone is configured to be attached to a head in a worn state, and collect a first vibration signal. The second bone conduction microphone is connected to the fastener via the first flexible connection structure, and the second bone conduction microphone is configured to be separated from the head in the worn state, and collect a second vibration signal. The controller is configured to perform noise reduction processing on the first vibration signal based on the second vibration signal.

The fastener is configured to fasten the headset to the head, and the fastener is configured to clamp the head or a neck.

The first bone conduction microphone is configured to be attached to the head in the worn state. Therefore, the first vibration signal collected by the first bone conduction microphone mainly includes a human voice signal and an ambient noise signal, and the human voice signal is transmitted in a bone conduction manner.

The second bone conduction microphone is connected to the fastener via the first flexible connection structure, and is configured to be separated from the head in the worn state. Therefore, vibration of the head is not likely to be conducted to the second bone conduction microphone, and the second vibration signal collected by the second bone conduction microphone mainly includes the ambient noise signal.

The first flexible connection structure may also be referred to as a first soft connection structure, and all connecting pieces included in the first flexible connection structure are made of a flexible material.

The speaker is configured to play an audio signal.

The controller is configured to process a headset signal. The headset signal includes the first vibration signal, the second vibration signal, a to-be-played audio signal, and the like. The controller may also be referred to as a processor.

According to the technical solution provided in this disclosure, the first bone conduction microphone is disposed to be attached to the head in the worn state, so that the first vibration signal collected by the first bone conduction microphone is mainly the human voice signal transmitted in the bone conduction manner. Therefore, compared with the use of an air conduction microphone, this improves a signal-to-noise ratio of a wanted vibration signal in a high ambient noise scenario, and improves call quality of a user.

In addition, in addition to the human voice signal, the first vibration signal further includes the ambient noise signal. The second bone conduction microphone is disposed to be connected to the fastener via the first flexible connection structure, and separated from the head in the worn state, so that the second vibration signal collected by the second bone conduction microphone mainly includes the ambient noise signal. In this way, the controller can perform noise reduction processing on the first vibration signal based on the second vibration signal, so that the ambient noise signal in the first vibration signal is effectively reduced, and the call quality of the user is further improved.

It should be noted that the first flexible connection structure is disposed to connect the second bone conduction microphone to the fastener, so that the vibration of the head (namely, the human voice signal) and vibration of a bone conduction speaker, when the speaker includes the bone conduction speaker, are greatly lost in the first flexible connection structure, and the second vibration signal collected by the second bone conduction microphone is a pure ambient noise signal. This facilitates noise reduction processing subsequently performed on the first vibration signal based on the second vibration signal.

In a possible implementation, the first flexible connection structure includes a flexible electrical connection line, and the flexible electrical connection line is separately connected to the fastener and the second bone conduction microphone, and is separately electrically connected to the controller and the second bone conduction microphone.

In a possible implementation, the first flexible connection structure further includes a flexible mechanical connecting piece, the flexible mechanical connecting piece is separately connected to the fastener and the second bone conduction microphone, and the flexible mechanical connecting piece is configured to bear pull force between the second bone conduction microphone and the fastener.

In a possible implementation, the flexible mechanical connecting piece includes a flexible mechanical connection line.

In a possible implementation, the flexible mechanical connecting piece includes a flexible mechanical connection pillar, and the flexible electrical connection line penetrates the flexible mechanical connection pillar.

In a possible implementation, the flexible mechanical connecting piece includes a flexible mechanical connection ring, and the flexible electrical connection line penetrates the flexible mechanical connection ring.

In a possible implementation, a Young's modulus of the first flexible connection structure is less than 0.1 gigapascals (GPa).

In a possible implementation, a Young's modulus of the flexible electrical connection line is less than 0.1 GPa.

In a possible implementation, a Young's modulus the flexible mechanical connecting piece is less than 0.1 GPa.

In a possible implementation, the second bone conduction microphone is located on a side that is of the fastener and that is away from the head.

In a possible implementation, the controller is configured to separately perform echo cancellation processing on the first vibration signal and the second vibration signal, and perform, based on a second vibration signal obtained through the echo cancellation processing, noise reduction processing on a first vibration signal obtained through the echo cancellation processing.

In a possible implementation, the first bone conduction microphone is fastened to one side of the fastener, and the first bone conduction microphone is configured to be attached to the head under an action of the fastener.

According to the technical solution provided in this disclosure, the first bone conduction microphone is fastened to one side of the fastener. This ensures tightness of attachment between the first bone conduction microphone and the head, and facilitates collection of the human voice signal by the first bone conduction microphone. In addition, this makes the headset more portable and easier to use.

In a possible implementation, the first bone conduction microphone is connected to the fastener via a second flexible connection structure.

The second flexible connection structure may also be referred to as a second soft connection structure. All connecting pieces included in the second flexible connection structure are made of a flexible material, so that when the fastener vibrates, it is not likely for the fastener to drive, via the second flexible connection structure, the first bone conduction microphone to vibrate. In addition, the second flexible connection structure may also implement an electrical connection between the first bone conduction microphone and the controller.

According to the technical solution provided in this disclosure, the first bone conduction microphone is disposed to be connected to the fastener via the second flexible connection structure, so that vibration of the fastener is not likely to be conducted to the first bone conduction microphone. Therefore, when the speaker includes the bone conduction speaker, the vibration of the bone conduction speaker is not likely to be collected by the first bone conduction microphone, thereby reducing impact of the bone conduction speaker on the first bone conduction microphone.

In a possible implementation, the first bone conduction microphone is configured to be clamped between a hat belt of a hat and a chin of the head.

The hat may be a safety helmet or a helmet, and the hat belt may alternatively be referred to as a safety belt, a safety rope, or the like.

In a possible implementation, the speaker includes a first speaker and a second speaker. The first speaker is an air conduction speaker, and is located on a same side of the fastener as the first bone conduction microphone. The second speaker is located on the other side of the fastener.

According to the technical solution provided in this disclosure, the speaker is disposed to include the first speaker and the second speaker that are located on two sides of the fastener, so that the first speaker and the second speaker can correspond to two ears respectively, and the headset can implement stereo effect.

In addition, the first speaker is disposed as the air conduction speaker, so that impact of the first speaker on the first bone conduction microphone can be reduced. It may be understood that, if the first speaker is a bone conduction speaker, when the first speaker plays an audio signal, the audio signal is collected by the first bone conduction microphone. As a result, the first vibration signal collected by the first bone conduction microphone includes a large amount of noise (echo).

In a possible implementation, the first speaker has an air conduit.

The air conduit is mostly used in a radio communication device like a walkie-talkie. The air conduit is characterized by a transparent spiral conduit that introduces sound to the ear from an earbud and deep into an ear canal through a single-section sleeve. The air conduit has good sound insulation performance and is not susceptible to external interference. In addition, in a very quiet environment, the air conduit does not have a disadvantage of sound leakage of a moving-coil earbud, and has high confidentiality.

According to the technical solution provided in this disclosure, the first speaker is disposed to have the air conduit, so that the audio signal played by the first speaker is less likely to leak. Therefore, the audio signal is less likely to be collected by the first bone conduction microphone, thereby further reducing the impact of the first speaker on the first bone conduction microphone.

In a possible implementation, the second speaker is a bone conduction speaker, and the second speaker is configured to be attached to the head under the action of the fastener.

According to the technical solution provided in this disclosure, the first speaker is disposed to be the air conduction speaker, and the second speaker is disposed to be the bone conduction speaker, so that the two speakers can complement each other. When a signal-to-noise ratio of the bone conduction speaker is low, the air conduction speaker may be used. When a signal-to-noise ratio of the air conduction speaker is low, or in an application scenario in which the ear cannot be blocked, the bone conduction speaker may be used, thereby improving reliability of a call using the headset. The scenario in which the ear cannot be blocked may be an industrial scenario like a coal mine. In this scenario, if the ear is blocked by the headset, a danger may occur because abnormal sound cannot be heard.

In a possible implementation, the controller is configured to obtain a to-be-played audio signal, separately perform first frequency response compensation processing and second frequency response compensation processing on the audio signal to obtain a first audio signal and a second audio signal, and transmit the first audio signal and the second audio signal to the first speaker and the second speaker respectively.

According to the technical solution provided in this disclosure, frequency response compensation is performed on the to-be-played audio signal, so that play results of the first speaker and the second speaker are more accurate.

According to a second aspect, this disclosure provides an over-ear headphone. The over-ear headphone includes a device body and the headset according to any implementation of the first aspect. The device body includes glasses or a helmet.

According to a third aspect, this disclosure provides a headset signal processing method, where the method is applied to the controller of the headset according to any implementation of the first aspect. The method includes obtaining a first vibration signal collected by the first bone conduction microphone and a second vibration signal collected by the second bone conduction microphone, and performing noise reduction processing on the first vibration signal based on the second vibration signal.

In a possible implementation, performing noise reduction processing on the first vibration signal based on the second vibration signal includes separately performing echo cancellation processing on the first vibration signal and the second vibration signal, and performing, based on a second vibration signal obtained through the echo cancellation processing, noise reduction processing on a first vibration signal obtained through the echo cancellation processing.

In a possible implementation, when the speaker includes a first speaker and a second speaker, the method further includes obtaining a to-be-played audio signal, separately performing first frequency response compensation processing and second frequency response compensation processing on the audio signal to obtain a first audio signal and a second audio signal, and transmitting the first audio signal and the second audio signal to the first speaker and the second speaker respectively.

According to a fourth aspect, this disclosure provides a headset signal processing apparatus, where the apparatus is located in the controller of the headset according to any implementation of the first aspect, and the apparatus includes an obtaining module configured to obtain a first vibration signal collected by the first bone conduction microphone and a second vibration signal collected by the second bone conduction microphone, and a noise reduction module configured to perform noise reduction processing on the first vibration signal based on the second vibration signal.

In a possible implementation, the noise reduction module is configured to separately perform echo cancellation processing on the first vibration signal and the second vibration signal, and perform, based on a second vibration signal obtained through the echo cancellation processing, noise reduction processing on a first vibration signal obtained through the echo cancellation processing.

In a possible implementation, the obtaining module is further configured to obtain a to-be-played audio signal.

The apparatus further includes a frequency response compensation module configured to separately perform first frequency response compensation processing and second frequency response compensation processing on the audio signal to obtain a first audio signal and a second audio signal, and a transmission module configured to transmit the first audio signal and the second audio signal to the first speaker and the second speaker respectively.

According to a fifth aspect, this disclosure provides a computer-readable storage medium. The computer-readable storage medium stores at least one computer instruction, and the computer instruction is read by a controller of a headset, so that the headset performs the headset signal processing method according to any implementation of the third aspect.

According to a sixth aspect, this disclosure provides a computer program product. The computer program product includes computer instructions, and the computer instructions are stored in a computer-readable storage medium. A controller of a headset reads the computer instructions from the computer-readable storage medium, and the controller executes the computer instructions, so that the headset performs the headset signal processing method according to any implementation of the third aspect.

According to a seventh aspect, this disclosure provides a chip, including a memory and a controller. The memory is configured to store computer instructions, and the controller is configured to invoke the computer instructions from the memory and run the computer instructions, to perform the headset signal processing method according to any implementation of the third aspect.

### BRIEF DESCRIPTION OF DRAWINGS

FIG. 1 is a diagram of a headset according to an embodiment of this disclosure;

FIG. 2 is a diagram of a connection manner between a second bone conduction microphone and a fastener according to an embodiment of this disclosure;

FIG. 3 is a diagram of a connection manner between a second bone conduction microphone and a fastener according to an embodiment of this disclosure;

FIG. 4 is a diagram of a connection manner between a second bone conduction microphone and a fastener according to an embodiment of this disclosure;

FIG. 5 is a diagram of a connection manner between a second bone conduction microphone and a fastener according to an embodiment of this disclosure;

FIG. 6 is a diagram of a headset according to an embodiment of this disclosure;

FIG. 7 is a diagram of a headset according to an embodiment of this disclosure;

FIG. 8 is a diagram of a headset according to an embodiment of this disclosure;

FIG. 9 is a diagram of a headset according to an embodiment of this disclosure;

FIG. 10 is a diagram of an echo generation principle according to an embodiment of this disclosure;

FIG. 11 is a diagram of a headset signal processing module according to an embodiment of this disclosure;

FIG. 12 is a flowchart of a headset signal processing method according to an embodiment of this disclosure; and

FIG. 13 is a diagram of a headset signal processing apparatus according to an embodiment of this disclosure.

### REFERENCE NUMERALS

1: fastener; 2: first bone conduction microphone; 3: second bone conduction microphone; 4: first flexible connection structure; 41: flexible electrical connection line; 42: flexible mechanical connecting piece; 5: first speaker; 6: second speaker; 7: second flexible connection structure; 100: microphone; and 200: speaker.

### DESCRIPTION OF EMBODIMENTS

A microphone used in a headset is usually an air conduction microphone, and the air conduction microphone collects human voice and ambient noise that are conducted in air.

Usually, the human voice is about 70 dB. However, in a high ambient noise scenario (for example, various industrial noise scenarios), the ambient noise is above 80 dB, and sometimes greater than 120 dB. As a result, the ambient noise drowns out the human voice, and the air conduction microphone cannot capture the human voice, which greatly affects a call of a user.

To resolve the foregoing technical problem, in the high ambient noise scenario, the air conduction microphone in the headset is usually replaced with a bone conduction microphone. The bone conduction microphone is attached to a head in a worn state, and collects vibration signals from a mouth and a throat of a person that are conducted through skin, muscles, and bones. The bone conduction microphone is used, and a signal-to-noise ratio of a wanted vibration signal in the high ambient noise scenario is improved to some extent.

However, in the high ambient noise scenario, vibration caused by the ambient noise is also collected by the bone conduction microphone. As a result, there is still high background noise when the bone conduction microphone collects the human voice. Therefore, how to further reduce the ambient noise in the vibration signal collected by the headset is a technical problem worth studying.

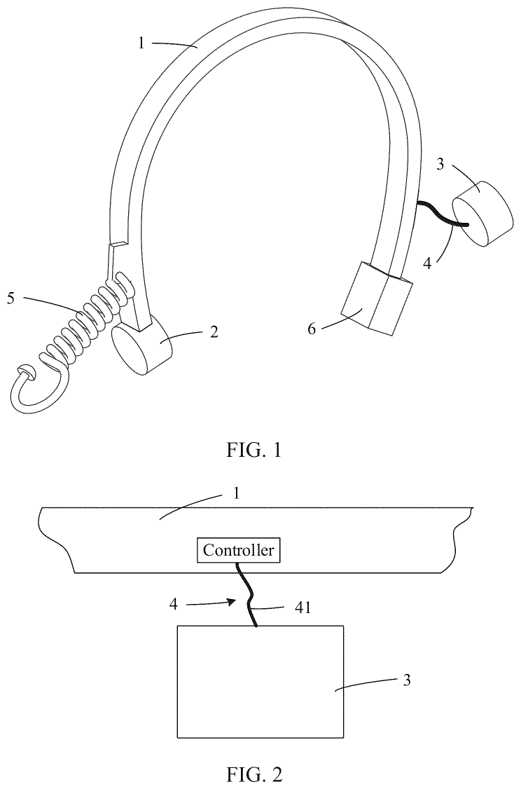

In view of the foregoing technical problem, an embodiment of this disclosure provides a headset. As shown in FIG. 1 and FIG. 6 to FIG. 9, the headset includes a fastener 1, a first bone conduction microphone 2, a second bone conduction microphone 3, a speaker, and a controller. The first bone conduction microphone 2, the second bone conduction microphone 3, and the speaker are all connected to the fastener 1. The first bone conduction microphone 2 is configured to be attached to a head in a worn state, and collect a first vibration signal. The second bone conduction microphone 3 is configured to be separated from the head in the worn state, and collect a second vibration signal. The controller is configured to perform noise reduction processing on the first vibration signal based on the second vibration signal.

The fastener 1 is configured to fasten the headset to the head. A type of the fastener 1 is not limited in embodiments of this disclosure. In some examples, the fastener 1 is configured to clamp the head or a neck. For example, the fastener 1 is a fastener on the head or on the neck.

The first bone conduction microphone 2 is attached to the head in the worn state. Therefore, the first vibration signal collected by the first bone conduction microphone 2 is mainly a human voice signal and an ambient noise signal that are propagated in a bone conduction manner.

The second bone conduction microphone 3 is separated from the head in the worn state. Therefore, the collected second vibration signal is mainly the ambient noise signal.

The speaker is configured to play an audio signal.

The controller is configured to process a headset signal. The headset signal includes the first vibration signal, the second vibration signal, a to-be-played audio signal, and the like. The controller may also be referred to as a processor.

According to the technical solution provided in this embodiment of this disclosure, the first bone conduction microphone 2 and the second bone conduction microphone 3 are disposed in the headset, the first bone conduction microphone 2 is attached to the head in the worn state, and the second bone conduction microphone 3 is separated from the head in the worn state, so that the first vibration signal collected by the first bone conduction microphone 2 mainly includes the human voice signal and the ambient noise signal, and the second vibration signal collected by the second bone conduction microphone 3 mainly includes the ambient noise signal.

In this way, the controller can perform noise reduction processing on the ambient noise signal in the first vibration signal based on the second vibration signal, so that the ambient noise signal in the first vibration signal can be effectively reduced, and a signal-to-noise ratio and call quality of a user can be improved.

In addition, the ambient noise is collected by using the second bone conduction microphone 3 instead of an air conduction microphone, so that the microphone that collects the ambient noise and the microphone that collects the human voice are microphones of a same type. In this way, processing is simpler and effect is better when noise reduction processing is performed on the first vibration signal.

In some examples, as shown in FIG. 1 to FIG. 9, the second bone conduction microphone 3 is connected to the fastener 1 via a first flexible connection structure 4.

The first flexible connection structure 4 may also be referred to as a first soft connection structure. All connecting pieces included in the first flexible connection structure 4 are made of a flexible material, so that when the fastener 1 vibrates, it is not likely for the fastener 1 to drive, via the first flexible connection structure 4, the second bone conduction microphone 3 to vibrate. In some examples, a Young's modulus of a material of the first flexible connection structure 4 is less than 0.1 GPa.

According to the technical solution provided in this embodiment of this disclosure, the first flexible connection structure 4 is disposed to connect the second bone conduction microphone 3 to the fastener 1, so that vibration of the fastener 1 is not likely to be conducted to the second bone conduction microphone 3. Therefore, both vibration of the head (namely, the human voice signal) and vibration of a bone conduction speaker, when the speaker includes the bone conduction speaker, are not likely to be conducted to the second bone conduction microphone 3 via the fastener 1, and the second vibration signal collected by the second bone conduction microphone 3 is a pure ambient noise signal. This facilitates noise reduction processing subsequently performed on the first vibration signal based on the second vibration signal.

The following describes the first flexible connection structure 4 by using an example.

In some examples, as shown in FIG. 2 to FIG. 5, the first flexible connection structure 4 includes a flexible electrical connection line 41, and the flexible electrical connection line 41 is separately connected to the fastener 1 and the second bone conduction microphone 3, and is separately electrically connected to the controller and the second bone conduction microphone 3. A Young's modulus of a material of the flexible electrical connection line 41 may be less than 0.1 GPa.

In some examples, as shown in FIG. 2, while implementing the electrical connection between the controller and the second bone conduction microphone 3, the flexible electrical connection line 41 is further configured to bear pull force between the second bone conduction microphone 3 and the fastener 1.

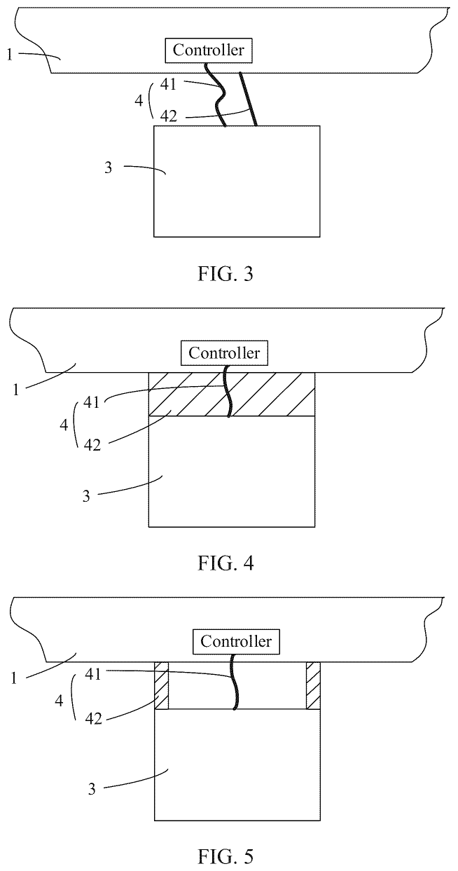

In some other examples, as shown in FIG. 3 to FIG. 5, the first flexible connection structure 4 further includes a flexible mechanical connecting piece 42, two ends of the flexible mechanical connecting piece 42 are connected to the fastener 1 and the second bone conduction microphone 3 respectively, and the flexible mechanical connecting piece 42 is configured to bear the pull force between the second bone conduction microphone 3 and the fastener 1.

In some examples, a Young's modulus of a material of the flexible mechanical connecting piece 42 is less than 0.1 GPa.

A form of the flexible mechanical connecting piece 42 is not limited in this embodiment of this disclosure. The following provides an example for description.

In some examples, as shown in FIG. 3, the flexible mechanical connecting piece 42 includes a flexible mechanical connection line. The flexible mechanical connection line is configured to bear the pull force between the second bone conduction microphone 3 and the fastener 1. There may be one or more flexible mechanical connection lines. This is not further limited in this embodiment of this disclosure.

In some examples, as shown in FIG. 4, the flexible mechanical connecting piece 42 includes a flexible mechanical connection pillar, and the flexible electrical connection line 41 penetrates the flexible mechanical connection pillar. The flexible mechanical connection pillar is configured to bear the pull force between the second bone conduction microphone 3 and the fastener 1.

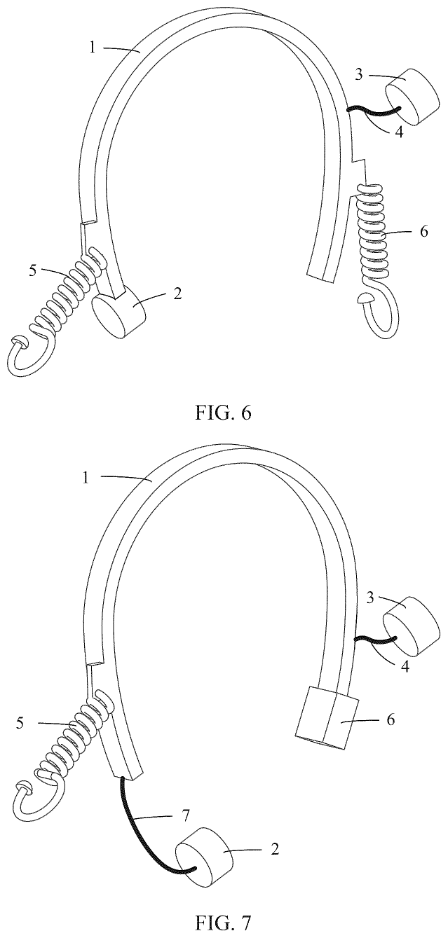

In some examples, as shown in FIG. 5, the flexible mechanical connecting piece 42 includes a flexible mechanical connection ring, and the flexible electrical connection line 41 penetrates the flexible mechanical connection ring. The flexible mechanical connection ring is configured to bear the pull force between the second bone conduction microphone 3 and the fastener 1.

In addition, when the first flexible connection structure 4 includes the flexible mechanical connecting piece 42, to further reduce vibration conduction through the flexible electrical connection line 41, the flexible electrical connection line 41 may be in a relaxed state (a non-tightened state).

In some examples, the second bone conduction microphone 3 is located on a side that is of the fastener 1 and that is away from the head.

An implementation in which noise reduction processing is performed on the first vibration signal based on the second vibration signal is not limited in this embodiment of this disclosure. In some examples, noise reduction processing may be performed on the first vibration signal based on the first vibration signal and the second vibration signal by using a spectral subtraction method. The following describes the spectral subtraction method by using an example.

It is assumed that the first vibration signal is a(n), and the second vibration signal is b(n).

Fast Fourier transform (FFT) is performed on the first vibration signal a (n) to obtain A(w), where A(w) includes a human voice spectrum and an ambient noise spectrum.

FFT transform is performed on the second vibration signal b(n) to obtain B(w), where B(w) is the ambient noise spectrum.

Then, B(w) is subtracted from A(w) to obtain S(w). In this case, S(w) is a pure human voice spectrum.

Finally, inverse FFT (IFFT) is performed on S(w) to obtain s(n), where s(n) is a pure human voice signal obtained by performing noise reduction on the first vibration signal a(n).

In some examples, before noise reduction processing is performed on the first vibration signal based on the second vibration signal, echo cancellation processing may alternatively be separately performed on the first vibration signal and the second vibration signal.

In other words, in some examples, the controller is configured to separately perform echo cancellation processing on the first vibration signal and the second vibration signal, and then, perform, based on a second vibration signal obtained through the echo cancellation processing, noise reduction processing on a first vibration signal obtained through the echo cancellation processing.

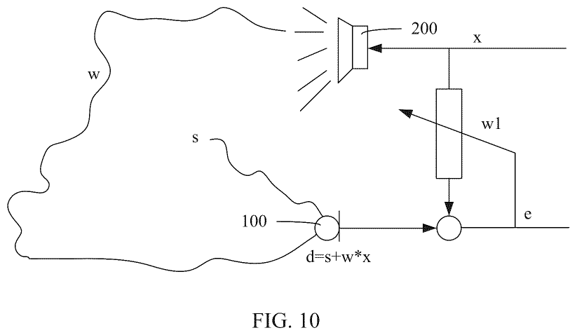

The following describes an echo cancellation processing principle by using an example with reference to FIG. 10.

When the user speaks to a microphone 100, an echo x is formed in real time at a speaker 200. In this case, sound entering the microphone 100 is d=s+w*x, where s is human voice, w*x is sound obtained after x is attenuated in air, and w is an attenuation coefficient. w*x is an echo signal received by the microphone 100, and needs to be canceled.

A filter is designed, and an approximate echo signal y′=w1*x is obtained after x passes through the filter.

After a sound signal entering the microphone 100 passes through the filter, y′ is subtracted. In other words, a sound signal obtained after the signal passes through the filter is e=d−y′=s+w*x−w1*x.

If e does not include s, that is, when there is no human voice, e is minimized, or e is even equal to 0, which is equivalent to estimating w1. A minimum mean square error method or the like may be used to minimize e. Details are not described herein. After w1 is estimated, a pure voice signal s obtained through the echo cancellation may be obtained based on d−y′, thereby implementing the echo cancellation.

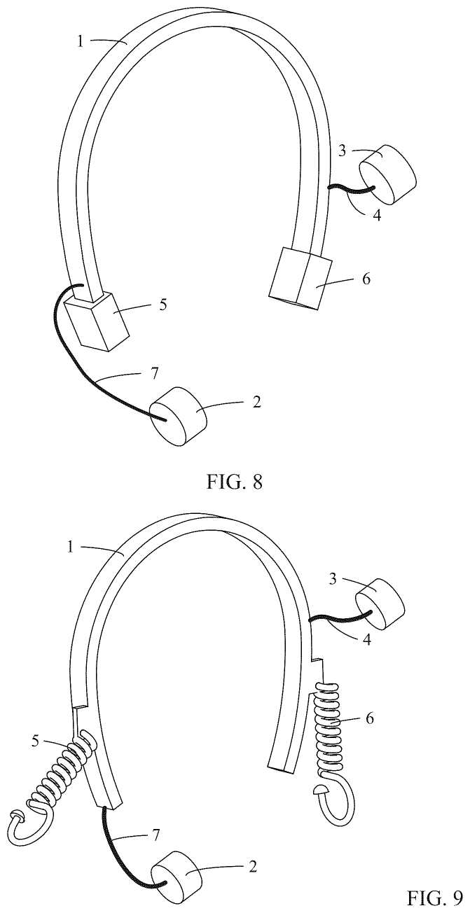

A connection manner between the first bone conduction microphone 2 and the fastener 1 is not limited in this embodiment of this disclosure. In some examples, as shown in FIG. 1 and FIG. 6, the first bone conduction microphone 2 is fastened to one side of the fastener 1, and the first bone conduction microphone 2 is configured to be attached to the head under an action of the fastener 1.

According to the technical solution provided in this embodiment of this disclosure, the first bone conduction microphone 2 is disposed to be fastened to one side of the fastener 1, and is attached to the head under the action of clamping force of the fastener 1. This ensures tightness of attachment between the first bone conduction microphone 2 and the head, and facilitates collection of the human voice signal by the first bone conduction microphone 2. In addition, this makes the headset more portable and easy to use.

In some other examples, as shown in FIG. 7 to FIG. 9, the first bone conduction microphone 2 is connected to the fastener 1 via a second flexible connection structure 7.

The second flexible connection structure 7 may also be referred to as a second soft connection structure. All connecting pieces included in the second flexible connection structure 7 are made of a flexible material, so that when the fastener 1 vibrates, it is not likely for the fastener 1 to drive, via the second flexible connection structure 7, the first bone conduction microphone 2 to vibrate. In addition, in some examples, the second flexible connection structure 7 may also implement an electrical connection between the first bone conduction microphone 2 and the controller, and the controller may be fastened to the fastener 1.

According to the technical solution provided in this embodiment of this disclosure, the first bone conduction microphone 2 is disposed to be connected to the fastener 1 via the second flexible connection structure 7, so that the vibration of the fastener 1 is not likely to be conducted to the first bone conduction microphone 2. Therefore, when the speaker includes the bone conduction speaker, the vibration of the bone conduction speaker is not likely to be collected by the first bone conduction microphone 2, thereby reducing impact of the bone conduction speaker on the first bone conduction microphone 2.

In some examples, as shown in FIG. 7 to FIG. 9, the second flexible connection structure 7 includes at least one flexible connection line.

The flexible connection line may include a conducting wire, and the conducting wire is connected to the controller and the first bone conduction microphone 2.

It should be noted that, for a case in which the first bone conduction microphone 2 is connected to the fastener 1 through the flexible connection line, when the first bone conduction microphone 2 cannot be attached to the head under the action of the fastener 1, another auxiliary component is required to attach the first bone conduction microphone 2 to the head.

In some examples, the auxiliary component is a hat belt of a hat, and the first bone conduction microphone 2 is configured to be clamped between the hat belt and a chin of the head. The hat may be a safety helmet or a helmet, and the hat belt may alternatively be referred to as a safety belt, a safety rope, or the like.

A specific implementation of the second flexible connection structure 7 may be the same as the implementation of the first flexible connection structure 4. Details are not described herein again.

A quantity of speakers and a type of the speaker included in the headset are not limited in this embodiment of this disclosure. The following provides an example for description.

In some examples, there is one speaker.

In some other examples, as shown in FIG. 1 and FIG. 6 to FIG. 9, the speaker includes a first speaker 5 and a second speaker 6, and the first speaker 5 and the second speaker 6 are respectively located on two sides of the fastener 1.

According to the technical solution provided in this embodiment of this disclosure, the speaker is disposed to include the first speaker 5 and the second speaker 6 that are located on two sides of the fastener 1, so that the first speaker 5 and the second speaker 6 can correspond to two ears respectively, and the headset can implement stereo effect.

The following describes types of the first speaker 5 and the second speaker 6 with reference to a specific connection manner between the first bone conduction microphone 2 and the fastener 1.

(1) For a case in which the first bone conduction microphone 2 is fastened to one side of the fastener 1 (it is assumed that the first speaker 5 and the first bone conduction microphone 2 are located on a same side of the fastener 1):

To reduce impact of the first speaker 5 on collecting the first vibration signal by the first bone conduction microphone 2, the first speaker 5 is an air conduction speaker.

It may be understood that, if the first speaker 5 is a bone conduction speaker, a vibration signal generated when the first speaker 5 plays an audio signal is collected by the first bone conduction microphone 2. As a result, the first vibration signal collected by the first bone conduction microphone 2 includes a large amount of noise.

In some examples, to further reduce the impact of the first speaker 5 on the first bone conduction microphone 2, as shown in FIG. 1 and FIG. 6, the first speaker 5 has an air conduit.

The air conduit is mostly used in a radio communication device like a walkie-talkie. The air conduit is characterized by a transparent spiral conduit that introduces sound to the ear from an earbud and deep into an ear canal through a single-section sleeve.

The air conduit has good sound insulation performance and is not susceptible to external interference. In addition, in a very quiet environment, the air conduit does not have a disadvantage of sound leakage of a moving-coil earbud, and has high confidentiality. Therefore, the audio signal played by the first speaker 5 is not likely to be leaked and collected by the first bone conduction microphone 2.

For the second speaker 6, because the second speaker 6 and the first bone conduction microphone 2 are not located on a same side, the second speaker 6 may be any type of speaker.

In some examples, as shown in FIG. 1, the second speaker 6 is a bone conduction speaker. The bone conduction speaker 6 is configured to be attached to the head under the action of the fastener 1.

According to the technical solution provided in this embodiment of this disclosure, the first speaker 5 is disposed to be the air conduction speaker, and the second speaker 6 is disposed to be the bone conduction speaker, so that the two speakers can complement each other.

When a signal-to-noise ratio of the bone conduction speaker is low, the air conduction speaker may be used. When a signal-to-noise ratio of the air conduction speaker is low, or in an application scenario in which the ear cannot be blocked, the bone conduction speaker may be used, thereby improving reliability of a call using the headset. The scenario in which the ear cannot be blocked may be an industrial scenario like a coal mine. In this scenario, if the ear is blocked by the headset, a danger may occur because abnormal sound cannot be heard.

Certainly, in some other examples, as shown in FIG. 6, the second speaker 6 may alternatively be an air conduction speaker, so that the impact of the speaker on the first bone conduction microphone 2 can be further reduced.

The second speaker 6 may have an air conduit, or may not have an air conduit. This is not limited in this embodiment of this disclosure.

(2) For a case in which the first bone conduction microphone 2 is connected to the fastener 1 via the second flexible connection structure 7 (it is assumed that the first speaker 5 is close to the first bone conduction microphone 2):

Because the first bone conduction microphone 2 is not fastened to the fastener 1, even if the first speaker 5 is the bone conduction speaker, the first bone conduction microphone 2 is not excessively affected. Therefore, the first speaker 5 and the second speaker 6 may be any type of speaker.

In some examples, one of the first speaker 5 and the second speaker 6 is an air conduction speaker, and the other is a bone conduction speaker. For example, as shown in FIG. 7, the first speaker 5 is an air conduction speaker, and the second speaker 6 is a bone conduction speaker.

Certainly, alternatively, the first speaker 5 may be an air conduction speaker, and the second speaker 6 may be a bone conduction speaker.

In some examples, as shown in FIG. 8, both the first speaker 5 and the second speaker 6 are bone conduction speakers.

In some examples, as shown in FIG. 9, both the first speaker 5 and the second speaker 6 are air conduction speakers.

It should be noted that, when the first speaker 5 is an air conduction speaker, and the second speaker 6 is a bone conduction speaker, the second flexible connection structure 7 in FIG. 7 to FIG. 9 may alternatively be replaced with a rigid connecting piece, and the connecting piece is bent, so that the bent rigid connecting piece can extend a conduction path from the bone conduction speaker (the second speaker 6) to the first bone conduction microphone 2, and reduce impact of the second speaker 6 on the first bone conduction microphone 2.

When the speaker plays the audio signal, distortion occurs in the played audio signal. Therefore, before the audio signal is played, compensation needs to be performed on the distortion for the audio signal, so that the played audio signal is an accurate audio signal.

The following describes a frequency response compensation principle by using an example.

It is assumed that a to-be-played audio signal is x(n).

x(n) is played based on the speaker, and a playing result y(n) is recorded. In this case, frequency response distortion of the speaker is c=y(n)/x(n).

The frequency response distortion is inverted to obtain c′=x(n)/y(n), where c′ is a frequency response compensation function.

Before the to-be-played audio signal x(n) is played, x(n) is first compensated based on the frequency response compensation function. To be specific, an actually played audio signal is x(n)*c′, and a playing result of the speaker is x(n)*c′*c=x(n).

For a case in which the speaker includes the first speaker 5 and the second speaker 6, frequency response compensation needs to be separately performed on audio signals transmitted to the first speaker 5 and the second speaker 6.

In other words, in some examples, the controller is configured to obtain the to-be-played audio signal, separately perform first frequency response compensation processing and second frequency response compensation processing on the audio signal to obtain a first audio signal and a second audio signal, and transmit the first audio signal and the second audio signal to the first speaker 5 and the second speaker 6 respectively.

In some examples, if the obtained audio signal is one channel of audio signal, first frequency response compensation processing is performed on the channel of audio signal to obtain the first audio signal, and second frequency response compensation processing is performed on the channel of audio signal to obtain the second audio signal. Then, the first audio signal and the second audio signal are transmitted to the first speaker 5 and the second speaker 6 respectively.

In some examples, the obtained audio signal includes two channels of audio signals a first sub-audio signal and a second sub-audio signal. In this case, first frequency response compensation processing is performed on the first sub-audio signal to obtain the first audio signal, and second frequency response compensation processing is performed on the second sub-audio signal to obtain the second audio signal. Then, the first audio signal and the second audio signal are transmitted to the first speaker 5 and the second speaker 6 respectively for playing.

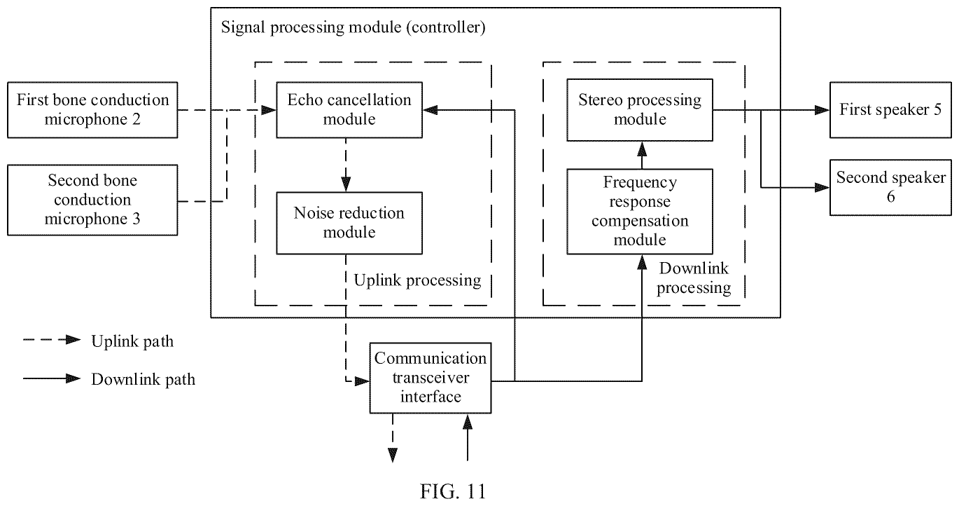

The following describes a process in which the controller processes the headset signal with reference to FIG. 11.

The headset signal includes an uplink signal and a downlink signal. The uplink signal is the vibration signals collected by the first bone conduction microphone 2 and the second bone conduction microphone 3, and signals obtained after the vibration signals are subsequently processed. The downlink signal is the to-be-played audio signal received by a communication transceiver interface of the headset, and a signal obtained after the to-be-played audio signal is subsequently processed.

Uplink signal processing:

Refer to a left part in FIG. 11. The first bone conduction microphone 2 and the second bone conduction microphone 3 transmit the collected first vibration signal and second vibration signal to an echo cancellation module. The echo cancellation module performs echo cancellation processing based on the first vibration signal, the second vibration signal, and the audio signal received by the communication transceiver interface.

Then, a first vibration signal and a second vibration signal that are obtained through the echo cancellation processing are transmitted to a noise reduction module, and the noise reduction module performs, based on the second vibration signal obtained through the echo cancellation processing, noise reduction processing on the first vibration signal obtained through the echo cancellation processing.

Finally, the first vibration signal obtained through the noise reduction processing is transmitted to the communication transceiver interface, and is sent by the communication transceiver interface to the outside.

Downlink signal processing:

Refer to a right part in FIG. 11. The communication transceiver interface receives the to-be-played audio signal.

Then, the to-be-played audio signal is transmitted to a frequency response compensation module, and the frequency response compensation module separately performs first frequency response compensation processing and second frequency response compensation processing on the audio signal to obtain the first audio signal and the second audio signal.

Finally, the first audio signal and the second audio signal are transmitted to a stereo processing module for processing, and after being processed, are transmitted to the first speaker 5 and the second speaker 6 respectively for playing, so that the first speaker 5 and the second speaker 6 can implement stereo playing effect.

An embodiment of this disclosure further provides a head-mounted device. The head-mounted device includes a device body and the headset.

In some examples, the device body is glasses.

The glasses may be virtual reality (VR) glasses, or may be augmented reality (AR) goggles or glasses.

In some examples, the fastener 1 of the headset is the same as a fastener of the glasses. In other words, the fastener 1 of the headset is a glasses frame of the glasses or glasses temples of the glasses frame, and the first bone conduction microphone 2, the second bone conduction microphone 3, and the speaker may all be connected to the glasses frame (glasses temples) of the glasses.

Certainly, the fastener 1 of the headset may not share a same fastener with the glasses. This is not limited in this embodiment of this disclosure.

In some other examples, the device body is a helmet.

The helmet may be a common helmet, for example, a common safety helmet. The helmet may alternatively be a smart helmet, for example, a smart safety helmet, a helmet-type camera, a forensic helmet, an intercom helmet, a communication helmet, a thermal imaging helmet, a monocular display smart helmet, and a Bluetooth intercom helmet.

In some examples, the fastener 1 of the headset is fastened to the helmet, and the headset is integrated with the helmet. In some other examples, the headset and the helmet may alternatively be two components separated from each other.

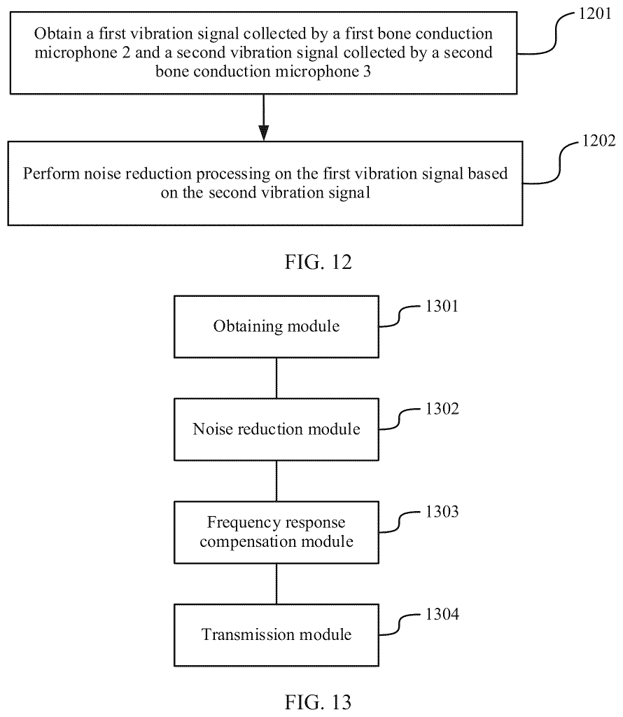

An embodiment of this disclosure further provides a headset signal processing method. The method is applied to the controller of the headset. As shown in FIG. 12, the method includes the following steps.

Step 1201: Obtain a first vibration signal collected by the first bone conduction microphone 2 and a second vibration signal collected by the second bone conduction microphone 3.

Step 1202: Perform noise reduction processing on the first vibration signal based on the second vibration signal.

In some examples, the performing noise reduction processing on the first vibration signal based on the second vibration signal includes separately performing echo cancellation processing on the first vibration signal and the second vibration signal, and performing, based on a second vibration signal obtained through the echo cancellation processing, noise reduction processing on a first vibration signal obtained through the echo cancellation processing.

In some examples, when the speaker includes a first speaker 5 and a second speaker 6, the method further includes obtaining a to-be-played audio signal, separately performing first frequency response compensation processing and second frequency response compensation processing on the audio signal to obtain a first audio signal and a second audio signal, and transmitting the first audio signal and the second audio signal to the first speaker 5 and the second speaker 6 respectively.

It should be noted that, for detailed content of the headset signal processing method, refer to the foregoing content. Details are not described herein again.

An embodiment of this disclosure further provides a headset signal processing apparatus. The apparatus is located in the controller of the headset. As shown in FIG. 13, the apparatus includes an obtaining module 1301 configured to obtain a first vibration signal collected by the first bone conduction microphone 2 and a second vibration signal collected by the second bone conduction microphone 3, and a noise reduction module 1302 configured to perform noise reduction processing on the first vibration signal based on the second vibration signal.

In some examples, the noise reduction module 1302 is configured to separately perform echo cancellation processing on the first vibration signal and the second vibration signal, and perform, based on a second vibration signal obtained through the echo cancellation processing, noise reduction processing on a first vibration signal obtained through the echo cancellation processing.

In some examples, the obtaining module 1301 is further configured to obtain a to-be-played audio signal.

The apparatus further includes a frequency response compensation module 1303 configured to separately perform first frequency response compensation processing and second frequency response compensation processing on the audio signal to obtain a first audio signal and a second audio signal, and a transmission module 1304 configured to transmit the first audio signal and the second audio signal to the first speaker 5 and the second speaker 6 respectively.

It should be noted that when the headset signal processing apparatus processes a headset signal, division into the foregoing functional modules is merely used as an example for description. In actual application, the foregoing functions can be allocated to different functional modules and implemented based on a requirement, that is, an inner structure of the headset signal processing apparatus is divided into different functional modules to implement all or some of the functions described above. In addition, the headset signal processing apparatus provided in the foregoing embodiments has a same concept as the headset signal processing method shown in FIG. 12. For a specific implementation process of the headset signal processing apparatus, refer to the corresponding method part. Details are not described herein again.

An embodiment of this disclosure further provides a computer-readable storage medium. The computer-readable storage medium stores at least one computer instruction, and the computer instruction is read by a controller of a headset, so that the headset performs the headset signal processing method provided in embodiments of this disclosure.

An embodiment of this disclosure further provides a computer program product. The computer program product includes computer instructions, and the computer instructions are stored in a computer-readable storage medium. A controller of a headset reads the computer instructions from the computer-readable storage medium, and the controller executes the computer instructions, so that the headset performs the headset signal processing method provided in embodiments of this disclosure.

An embodiment of this disclosure further provides a chip, including a memory and a controller. The memory is configured to store computer instructions, and the controller is configured to invoke the computer instructions from the memory and run the computer instructions, to perform the headset signal processing method provided in embodiments of this disclosure.

A person of ordinary skill in the art may be aware that method steps and units described with reference to embodiments disclosed in this specification can be implemented by electronic hardware, computer software, or a combination of computer software and electronic hardware. To clearly describe interchangeability of hardware and software, the foregoing has generally described steps and compositions of the embodiments based on functions. Whether the functions are performed by hardware or software depends on particular applications and design constraints of the technical solutions. A person of ordinary skill in the art may use different methods to implement the described functions for each particular application, but it should not be considered that the implementation goes beyond the scope of this disclosure.

In the several embodiments provided in this disclosure, the disclosed apparatus and method may be implemented in other manners. For example, the described apparatus embodiment is merely an example. For example, division into the units is merely logical function division and may be other division in an actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate components may or may not be physically separate, and components displayed as units may or may not be physical units, may be located in one position, or may be distributed on a plurality of network units. Some or all of the units may be selected based on actual requirements to achieve the objectives of the solutions of embodiments of this disclosure.

In addition, functional units in embodiments of this disclosure may be integrated into one processing unit, each of the units may exist alone physically, or two or more units may be integrated into one unit. The integrated unit may be implemented in a form of hardware, or may be implemented in a form of a software functional unit.

The foregoing descriptions are merely optional embodiments of this disclosure, but are not intended to limit this disclosure. Any modification, equivalent replacement, or improvement made without departing from the principle of this disclosure should fall within the protection scope of this disclosure.

1. A headset comprising:
a fastener;
a first bone conduction microphone coupled to the fastener and configured to:
attach to a head in a worn state; and
collect a first vibration signal;
a first flexible connection structure;
a second bone conduction microphone coupled to the fastener via the first flexible connection structure and configured to:
separate from the head in the worn state; and
collect a second vibration signal; and
a controller coupled to the first bone conduction microphone and the second bone conduction microphone and configured to perform, based on the second vibration signal, noise reduction processing on the first vibration signal.

2. The headset of claim 1, wherein the first flexible connection structure comprises a flexible electrical connection line separately coupled to the fastener and the second bone conduction microphone and further separately electrically coupled to the controller and the second bone conduction microphone.

3. The headset of claim 2, wherein the first flexible connection structure further comprises a flexible mechanical connecting piece configured to bear a pull force between the second bone conduction microphone and the fastener and comprising:
a first end coupled to the fastener; and
a second end coupled to the second bone conduction microphone.

4. The headset of claim 3, wherein the flexible mechanical connecting piece further comprises a flexible mechanical connection line.

5. The headset of claim 3, wherein the flexible mechanical connecting piece further comprises a flexible mechanical connection pillar, and wherein the flexible electrical connection line is configured to penetrate the flexible mechanical connection pillar.

6. The headset of claim 3, wherein the flexible mechanical connecting piece further comprises a flexible mechanical connection ring, and wherein the flexible electrical connection line is configured to penetrate the flexible mechanical connection ring.

7. The headset of claim 1, wherein the controller is further configured to:
perform a first echo cancellation processing on the first vibration signal to obtain a third vibration signal;
perform a second echo cancellation processing on the second vibration signal to obtain a fourth vibration signal; and
perform, based on the fourth vibration signal, noise reduction processing on the third vibration signal.

8. The headset of claim 1, wherein the fastener comprises a first side, and wherein the first bone conduction microphone is fastened to the first side and is configured to be attached to the head under an action of the fastener.

9. The headset of claim 1, further comprising a second flexible connection structure, wherein the first bone conduction microphone is coupled to the fastener via the second flexible connection structure.

10. The headset of claim 8, wherein the fastener further comprises a second side, and wherein the headset further comprises:
a first speaker that is an air conduction speaker and that is located on the first side; and
a second speaker located on the second side.

11. The headset of claim 10, wherein the first speaker comprises an air conduit.

12. The headset of claim 10, wherein the second speaker is a bone conduction speaker and is configured to be attached to the head under the action.

13. The headset of claim 10, wherein the controller is further configured to:
obtain a to-be-played audio signal;
perform a first frequency response compensation processing on the to-be-played audio signal to obtain a first audio signal;
perform a second frequency response compensation processing on the to-be-played audio signal to obtain a second audio signal;
transmit, to the first speaker, the first audio signal; and
transmit, to the second speaker, the second audio signal.

14. A head-mounted device comprising:
a device body comprising glasses or a helmet; and
a headset attached to the device body and comprising:
a fastener;
a first bone conduction microphone coupled to the fastener and configured to:
attach to a head in a worn state; and
collect a first vibration signal;
a first flexible connection structure;
a second bone conduction microphone coupled to the fastener via the first flexible connection structure and configured to:
separate from the head in the worn state; and
collect a second vibration signal; and
a controller coupled to the first bone conduction microphone and the second bone conduction microphone and configured to perform, based on the second vibration signal, noise reduction processing on the first vibration signal.

15. A headset signal processing method comprising:
obtaining a first vibration signal from a first bone conduction microphone of a headset;
obtaining a second vibration signal from a second bone conduction microphone of the headset; and
performing, based on the second vibration signal, a noise reduction processing on the first vibration signal.

16. The method of claim 15, wherein performing the noise reduction processing comprises:
performing a first echo cancellation processing on the first vibration signal to obtain a third vibration signal;
performing a second echo cancellation processing on the second vibration signal to obtain a fourth vibration signal; and
performing, based on the fourth vibration signal, the noise reduction processing on the third vibration signal.

17. The method of claim 15, further comprising:
obtaining a to-be-played audio signal;
performing a first frequency response compensation processing on the to-be-played audio signal to obtain a first audio signal;
performing a second frequency response compensation processing on the to-be-played audio signal to obtain a second audio signal;
transmitting, to a second speaker of the headset, the second audio signal; and
transmitting, the second speaker of the headset, the second audio signal.

18. The head-mounted device of claim 14, wherein the first flexible connection structure comprises a flexible electrical connection line separately coupled to the fastener and the second bone conduction microphone and further separately electrically coupled to the controller and the second bone conduction microphone.

19. The head-mounted device of claim 18, wherein the first flexible connection structure further comprises a flexible mechanical connecting piece configured to bear a pull force between the second bone conduction microphone and the fastener and comprising:
a first end coupled to the fastener; and
a second end coupled to the second bone conduction microphone.

20. The head-mounted device of claim 19, wherein the flexible mechanical connecting piece further comprises a flexible mechanical connection line.
